(19) United States
(12) Patent Application Publication
(10) Pub. No.: US 2018/0374267 A1
(43) Pub. Date: Dec. 27, 2018

(54) Method and System to Enhance Spectator Experience

(71) Applicant: Fernando Jose Yurkin, Deerfield Beach, FL (US)

(72) Inventor: Fernando Jose Yurkin, Deerfield Beach, FL (US)

(21) Appl. No.: 15/996,935

(22) Filed: Jun. 4, 2018

Related U.S. Application Data
(60) Provisional application No. 62/516,782, filed on Jun. 8, 2017.

(51) Int. Cl. G06T 19/00; G06Q 50/00; G06K 19/06; G06F 3/01; H04L 29/06

(52) U.S. Cl. CPC G06T 19/006; G06Q 50/01; H04L 65/4076; G06F 3/011; G06K 19/06103

(57) ABSTRACT

A system and method are provided for creating and viewing augmented reality (AR) animations at an event, such as a sporting event, and sharing the content live or in a timeline of a social network, connecting spectators and participants in a unique way. AR animations are triggered with a coded marker, such marker being an uncomplicated design. Markers would be found on bags, banner, clothes and like promotional material of said participate, or throughout the event venue.

### FIELD OF INVENTION

This invention relates to a system and method for creating AR animations, 2D graphics and sharing the footage via a social network.

### DESCRIPTION OF RELATED ART

U.S. Pat. Nos. 9,566,494; 9,451,405; 9,524,589 and US Patent Publication Nos. 2012/0244939; 2015/0174486; 2014/0172474 and 2006/0189389 relate generally to viewing people/profiles and schedule events and matches. Some referring to improving the spectator experience through AR. Some referring to designing AR coded markings directly on garments. While the event is getting the spectator more involved, it lacks a more interactive experience for the spectator that is physically at an event and spectators that are viewing remotely; where the onsite spectator could create unique fun videos/media. AR codes on garments also needs to be a straightforward process for the everyday sport competitor.

Commercial applications of augmented reality exist such as Layar, Wikitude, Junaio, Sekai Camera and others which use augmented reality to aid finding information about points of interest. See, e.g., www.layar.com, www.wikitude.org/en/, and www.junaio.com.

Products or services that are tailored to the user are prevalent, such as advertising models from Google based on search terms or advertising based on personal information of a user. For example, Apple postulates displaying advertising to a mobile customer using one of its devices based on marketing factors. To compute marketing factors the Apple system captures not only the machine identity, but search history, personal demographics, time of day, location, weather, loyalty program membership, media library, user opinion or opinions of friends and family, etc. (collectively, referred to as “marketing factors”). See, e.g., U.S. Publication Nos. 2010/0125492; 2009/0175499; 2009/0017787; 2009/0003662; 2009/0300122, and U.S. Pat. No. 7,933,900 (all incorporated herein by reference). Links to and use of social media, such as Facebook and Twitter, sometimes paired with location, are also possible indicators of a user behavior and user demographics. See e.g., U.S. Publication Nos. 2009/0003662; 2011/0090252, and U.S. Pat. Nos. 7,188,153; 7,117,254; 7,069,308 (all incorporated herein by reference).

Social networks are well known, and examples include LinkedIn.com, Google+ or Facebook.com and various social utilities to support social networking. Growing a social network can mean that a person needs to discover like-minded or compatible people who have similar interests or experiences to him or her. Identifying like-minded people, however, often requires a substantial amount of and time and effort because identifying new persons with common interests for friendships is difficult. For example, when two strangers meet, it may take a long and awkward conversation to discover their common interests or experiences.

Social networks, in general, track and enable connections between members (including people, businesses, and other entities). In particular, social networking websites allow members to communicate more efficiently information that is relevant to their friends or other connections in the social network. Social networks typically incorporate a system for maintaining connections among members in the social network and links to content that is likely to be relevant to the members. Social networks also collect and maintain information about the members of the social network. This information may be static, such as geographic location, employer, job type, age, music preferences, interests, and a variety of other attributes, or it may be dynamic, such as tracking a member's actions within the social network.

A typical modern computer-implemented social networking application requires each user to provide some biographical information, and/or identify his or her interests, and in some instances can suggest to the user other users with compatible interests. For example, some web sites such as LinkedIn.com or Facebook.com require participants to register as members. Each member can fill out a profile or provide other personal data such as professional interests, career information, interests in music, books, movies, and even information about political or religious beliefs. Matching algorithms can then use the profile or data provided to match members with members who are deemed compatible by the algorithms, under the assumption, for example, that matching people's interests and values can lead to successful new friendships or relationships within the social network. Some mobile device-based applications for identifying common interests require each user to configure the user's mobile device, including entering the user's interest, such as the things the user wishes to buy or sell, the kind of people the user wishes to meet, etc., before a social networking opportunity can be found for the user.

Typically, when a user who is also a member of a social network wishes to share information with other members of the social network, the user generally uploads or copies and pastes the information to a location on the social network or forwards the information in the form of a message or email to other members. Often, certain forms of information do not copy and paste very well from one medium to another, so additional formatting or modifications to the information may be required before it is suitable for viewing by other members. Therefore, the quality and type of shared information is limited and members may be less likely to share information with each other.

### SUMMARY OF INVENTION

Generally speaking, the system and methods of the present invention enhance the spectator experience at an event by sharing the event on a social network. The event (amateur or professional) features markers by Sponsor companies, award markers for participate and unique markers identifying said participate. Event includes participants that physically compete, onsite spectators (filming live at the event through a networked device) and offsite spectators (spectators viewing remotely through a networked device). Event could be viewed live or on timeline.

In one form, a method for sharing an event with members of a social network, is provided and includes an announcement to one or more members of a social network to physically join an event, where the invitation includes information such as; directions, weather conditions, event type, awards available, sponsors and time. Select if user is a participant or onsite spectator of said event. Onsite spectators would then have an option to start broadcasting when they arrive at said event, using GPS to verify the location of the event. Once onsite spectators start broadcasting, offsite spectators could view live feed(s). If more than one onsite spectator is broadcasting, offsite spectator could toggle between onsite spectator feeds. Onsite spectator could turn AR mode on or off.

In one embodiment, a system of sharing an event with members of a social network is provided and includes a device accompanying said onsite spectator during the event and a server associated with said network.

The system includes GPS to help identify events near said zip code. A camera icon appears at locations(s) where onsite spectator(s) is filming. An offsite spectator could select the camera icon to start viewing live event. Offsite spectator could leave a predetermined message, like “Nice Shot!” “Nice Shot,” is time stamped so members could view the clips associated with the message, creating a highlight real.

In one form, a method of rating a participate in an event, is provided and includes retrieving participants unique identifying marker, once identified; the participants information is saved to a server (card deck) where other participants (competitors) could later rate performance. Participants rating profile will be linked to videos posted by live spectators. Rating includes, but not limited to, skill ratings (example basketball: 2 point shot, 3 point shot, passing . . . ) accomplishments (highly viewed player, everyday competitor, . . . ) and Sponsorship awards (Atlanta Hawks, City Bank, TD Bank . . . ). Accomplishments and Sponsor awards are then printable as a coded marker and the participant could share his/her accomplishments on physical objects (example: clothes, bags, banners, cars, . . . ) where they could be viewed from an AR enabled device.

### BRIEF DESCRIPTION OF DRAWINGS

FIG. 1 is a front elevation view of a smart phone having a graphics display;

FIG. 2 is an overhead digital view of a basketball court with onsite spectators GPS positioning;

FIG. 3 is a block diagram depicting a wireless, client server architecture in accordance with a preferred embodiment of the present invention;

FIG. 4A is a front elevation view of the smart phone of FIG. 1 showing an onsite spectator representation of the basketball court of FIG. 2, with options turned off;

FIG. 4B is a front elevation view of the smart phone of FIG. 1 showing an onsite spectator representation of the basketball court of FIG. 2, with 2D option on and AR option off;

FIG. 4C is a front elevation view of the smart phone of FIG. 1 showing an onsite spectator representation of the basketball court of FIG. 2, with options turned on;

FIG. 5A is a front elevation view of the smart phone of FIG. 1 showing an offsite spectator representation of the basketball event of FIG. 2, with options off;

FIG. 5B is a front elevation view of the smart phone of FIG. 1 showing an onsite spectator representation of the basketball court of FIG. 2, with 2D option turned on and AR option off;

FIG. 5C is a front elevation view of the smart phone of FIG. 1 showing an onsite spectator representation of the basketball court of FIG. 2, with options turned on;

FIG. 6 is a depiction of how 2D graphics view on the smart phone of FIG. 1;

FIG. 7 is a flow diagram on how a coded marker is printed and depicted on the view of smart phone from FIG. 1;

FIG. 8 is also a flow diagram on how a sponsor marker is printed and depicted on the view of smart phone from FIG. 1;

FIG. 9 is a perspective of a portable device where the functionality is built into glasses or goggles worn;

FIG. 10 is a perspective of the back side the smart phone of FIG. 1;

### DETAILED DESCRIPTION

High bandwidth, wireless networks are becoming commonplace, as is the computing power of mobile devices. Further rendering engines are becoming readily available for wide ranging applications of artificial reality. Viewing an event, such as a sporting event, using a mobile device adds greatly to the user experience. Many sporting events, such as golf, can be enhanced using a mobile device and artificial reality. U.S. Pat. No. 7,855,638 and 9,566,494 describes several examples of a system and method for viewing such events. In such event viewing systems, the background can be a real world image (e.g. photograph) or a virtual world rendering, but in a preferred case, artificial reality is used to enhance the perspective viewing experience.

In creating such environments for the venue of the event, such as a basketball tournament, pick up games, soccer games, and the like; it is desirable to have sponsors and awards displayed in a unique way. Easy to print markers are then placed on physical objects at the event to create an augmented experience. Typically, the user selected position is an onsite spectators present position as determined by GPS. Thus, in a preferred embodiment the sport participant and offsite spectator (basketball, soccer, ect . . . ) is presented with a perspective view of the event from the onsite spectator's current position (i.e. “viewpoint”) with augmented objects visually presented to the offsite spectator.

The present system and methods also address many sport related functions that can be used in such an artificial reality or mixed reality environment. For example, a basic function in basketball is a spectator view watching a participant shoot a free throw, 2 point or 3 point shot. However, other functions exist, such as displaying suggested parks to visit, suggested sport to try out and award of the day. Other functions such as contests and betting can also be incorporated.

In the present application, the term “content” is used to encompass any artificial reality or virtual object, such as award message, sponsorship, weather alerts, participants awards, diagrams, event information, announcements and other types of alpha numeric displays. However, the content could also be a graphic, logo or brand. It shall be understood that other objects or graphics may also be enhanced and the term “content” is understood to include other objects.

In the present application, the term “social network” is used to refer to any process or system that tracks and enables connections between members (including people, businesses, and other entities) or subsets of members. The connections and membership may be static or dynamic and the membership can include various subsets within a social network. For example, a person's social network might include a subset of members interested in basketball and the person shares a basketball tournament only with the basketball interest subset. Further, a social network might be dynamically configured. For example, a social network could be formed for “Miami Beach Run for Hope” for September 12 and anyone interested could join the Miami Beach Run for Hope September 12 social network. Alternatively, anyone within a certain range of the event might be permitted to join. The permutations involving membership in a social network are many and not intended to be limiting.

A social network that tracks and enables the interactive web by engaging users to participate in, comment on and create content as a means of communicating with their social graph, other users and the public. In the context of the present invention, such sharing and social network participation includes a participate that joins an event, an onsite spectator to broadcast said event and an offsite spectator to view and comment on said event. Participate receives awards that they could print, to create AR content, the onsite spectator's AR enabled device interprets printable coded markers, to AR content, and offsite spectator has comments that they could add live, or in playback.

Examples of conventional social networks include LinkedIn.com or Facebook.com, Google Plus, Twitter (including Tweetdeck), social browsers such as Rockmelt, and various social utilities to support social interactions including integrations with HTML5 browsers.

www.Wikipedia.org/wiki/list_of_social_networking_sites lists several hundred social networks in current use. Dating sites, Listservs, and Interest groups can also server as a social network. Interest groups or subsets of a social network are particularly useful for inviting members to attend an event, such as Google+“circles” or Facebook “groups.” Individuals can build private social networks. Conventional social networking websites allow members to communicate more efficiently information that is relevant to their friends or other connections in the social network. Social networks typically incorporate a system for maintaining connections among members in the social network and links to content that is likely to be relevant to the members. Social networks also collect and maintain information about the members of the social network. This information may be static, such as geographic location, employer, job type, age, music preferences, interests, and a variety of other attributes, or it may be dynamic, such as tracking a member's actions within the social network. The methods and system hereof relate to dynamic events of a member's actions shared within a social network.

According to Hands-On Mobile App Testing: A Guide for Mobile Testers and Anyone Involved in the Mobile App Business—Daniel Knott, mobile applications are broken down to 3 subsets: Web Apps, Hybrid Apps and Native apps. Each has their pros and cons:

In this present application, the term “mobile app” or “AR enabled application” is used to include, but not limited to, the following app builds. Native apps are programmed with specific programming language for the specific mobile platform. For example, Android apps are developed in Java, whereas IOS apps are written in Objective-C or Swift. Native apps have full access to all-platform-specific libraries and APIs in order to take advantage of all the features a modern smartphone has to offer. Assuming the user has granted the necessary permissions, the app has direct access to the camera, GPS and all the other sensors. Developers are able to build apps that make use of system resources such as GPU and CPE to build powerful apps. Native apps generally exhibit excellent performance and are optimized for mobile platforms. In most cases, native apps look and feel great and are able to support every possible gesture on the touchscreen.

Hybrid apps, are apps that consist of different Web technologies such as HTML or JavaScript. Once the Web part has been built, developers are able to compile this code base to the different native formats: Android, iOS, Windows Phone, or BlackBerry. To compile the Web code into native mobile code, developers need to use a hybrid development framework such as PhoneGap. Such frameworks offer APIs to access the device-specific hardware features within the Web part of the app.

A mobile Web app is a Web site that can be accessed from the device's Web browser. Such Web sites are optimized for mobile browser usage and are independent of the mobile platform. Mobile Web apps are developed with Web technologies such as HTML and JavaScript, particularly with HTML5, CSS3, and JavaScript.

HTML5 offers developers the capability to implement mobile Web sites with animated and interactive elements. They can integrate audio or video files with use of positioning features as well as some local storage functionality. The use of HTML %, CSS3, and JavaScript makes it easy to develop mobile Web apps. Furthermore, mobile Web apps require no app store approval and can be easily and quickly updated.

However, mobile Web apps have some drawbacks. For example, they offer only very limited to no access to the device hardware features such as proximity or acceleration sensors. Mobile Web apps have no access to the camera, compass, microphone, or any kind of notifications. They tend to ve slower than native or hybrid apps because they need to download all the information that is shown on the screen.

Depending on the mobile browser, mobile Web apps can work and behave differently because not all mobile browsers support the full standards of HTML5, CSS3, and Java Script.

The most common positioning technology is GPS. As used herein, GPS—sometimes known as GNSS—is meant to include all of the current and future positioning systems that include satellites, such as the U.S. Navistar, GLONASS, Galileo, EGNOS, WAAS, MSAS, QZSS, etc. The accuracy of the positions, particularly of the participants, can be improved using known techniques, often called differential techniques, such as WAAS (wide area), LAAS (local area), Carrier-Phase Enhancement (CPGPS), Space Based Augmentation Systems (SBAS); Wide Area GPS Enhancement (WAGE), or Relative Kinematic Positioning (RKP). Even without differential correction, numerous improvements are increasing GPS accuracy, such as the increase in the satellite constellation, multiple frequencies (L.sub.1, L.sub.2, L.sub.5), modeling and AGPS improvements, software receivers, and ground station improvements. Of course, the positional degree of accuracy is driven by the requirements of the application. In the basketball example used to illustrate a preferred embodiment, onsite spectator location accuracy provided by WAAS with Assisted GPS would normally be acceptable. Further, some “events” might be held indoors and the same message enhancement techniques described herein used. Such indoor positioning systems include IMEO, Wi-Fi (Skyhook), Cell ID, pseudolites, repeaters, RSS on any electromagnetic signal (e.g. TV) and others known or developed.

The term “geo-referenced” means a message fixed to a particular location or object. Thus, the message might be fixed to a venue location, e.g., basketball net or fixed to a moving participant, e.g., a moving spectator or player. An object is typically geo-referenced using either a positioning technology, such as GPS, but can also be geo-referenced using machine vision. If machine vision is used (i.e. object recognition), applications can be “markerless” or use “markers,” sometimes known as “fiducials.” Marker-based augmented reality often uses a square marker with a high contrast. In this case, four corner points of a square are detected by machine vision using the square marker and three-dimensional camera information is computed using this information. Other detectable sources have also been used, such as embedded LED's or special coatings or QR codes. Applying AR to a marker which is easily detected is advantageous in that recognition and tracking are relatively accurate, even if performed in real time. So, in applications where precise registration of the AR message in the background environment is important, a marker based system has some advantages.

In a “markerless” system, AR uses a general natural image instead of a fiducial. In general, markerless AR uses a feature point matching method. Feature point matching refers to an operation for searching for and connecting the same feature points in two different images. A method for extracting a plane using a Simultaneous Localization and Map-building (SLAM)/Parallel Tracking and Mapping (PTAM) algorithm for tracking three-dimensional positional information of a camera and three-dimensional positional information of feature points in real time and providing AR using the plane has been suggested. However, since the SLAM/PTAM algorithm acquires the image so as to search for the feature points, computes the three-dimensional position of the camera and the three-dimensional positions of the feature points, and provides AR based on such information, a considerable computation is necessary. A hybrid system can also be used where a readily recognized symbol or brand is geo-referenced and machine vision substitutes the AR message.

In the present application, the venue for the sporting event can be a real view or mix view (mixed reality). Real view could be the broadcast(s) of onsite spectators, mix views could be a digital representation as to where onsite spectator is seated in respect to the event (basketball match) so the offsite spectator could toggle between views. A convenient way of understanding the animation of the present invention is a unique coded marker is printed and placed on venue equipment (basketball hoop, soccer net, around stadium or park) or participants sporting goods (clothing, bag, banner, bottle . . . ), that marker has an augmented reality graphic, 2d or 3d, that is associated and animated through an AR capable device. Because the use of a real environment as the background is common, “augmented reality” (AR) often refers to a technology of inserting a virtual reality graphic (object) into an actual digital image and generating an image in which a real object and a virtual object are mixed (i.e. “mixed reality”). AR is characterized in that supplementary information using a virtual graphic may be layered or provided onto an image acquired of the real world. Multiple layers of real and virtual reality can be mixed. In such applications the placement of an object or “registration” with other layers is important. That is, the position of objects or layers relative to each other based on a positioning system should be close enough to support the application. As used herein, “artificial reality” (“AR”) is sometimes used interchangeably with “mixed” or “augmented” reality, it being understood that the background environment can be real or virtual.

### I. Overview

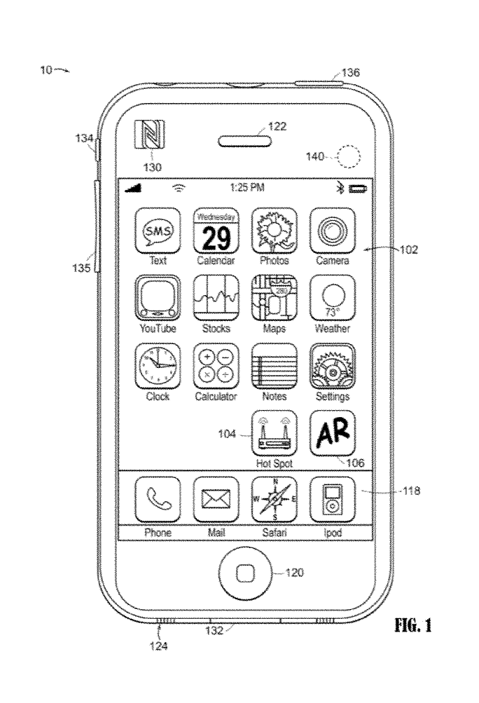

In the drawings, basketball is used as an example of an event where the event can be created and shared on a social network, enhancing and expanding the participant and spectator experience. Turning to the drawings, an illustrative embodiment uses a mobile device, such as smart phone 10 of FIG. 1, accompanying the onsite spectator. The onsite spectator selects AR application 106 on the touch sensitive graphics display 102. Smart phone 10 includes a variety of sensors, including, a gyroscope for determining the orientation, an accelerometer, ambient light sensor, proximity sensor, magnetic sensor, pressure sensor, temperature sensor, humidity sensor and a digital compass. Additionally, phone 10 includes one or more radios, such as a packet radio, a cell radio, WiFi, Bluetooth, GPS and near field. Of course, other devices can be used such as the dedicated basketball handheld devices as well as a tablet computer having GPS, especially the tablets with screen sizes larger than a smart phone but smaller than about 10 inches to aid portability, such as a Dell Streak, Motorola Xoom, or Samsung Galaxy. In some embodiments, the device can be a tablet affixed to a golf cart with a camera oriented in the direction of travel. That is, in some embodiments, a wireless camera connected to a Bluetooth compatible device 10 may be preferred. Examples of such cameras are JonesCAM LX, Vuzix iWear CamAR available from Vuzix Corporation, Rochester, N.Y., AT-1 Wireless available from Dogcam, and ContourGPS available from Contour HD.

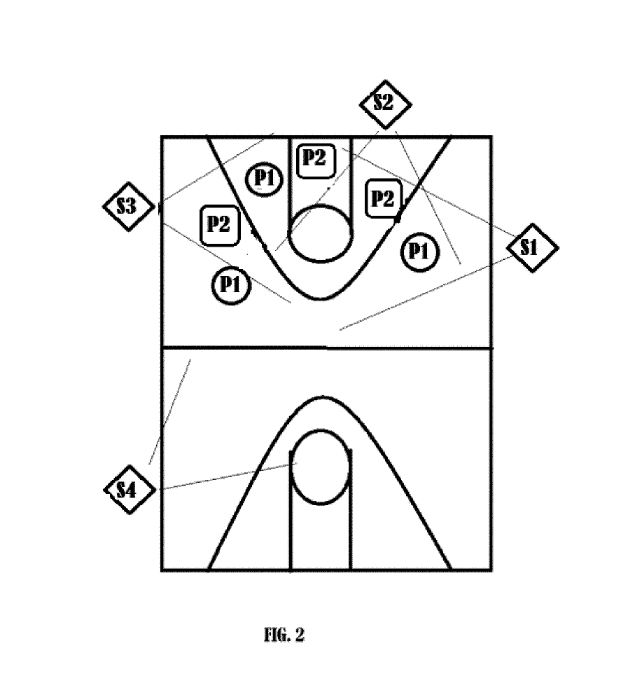

FIG. 2 is an illustrative example of an overhead view of a basketball event that is taking place. You have participants (P's and P2's) competing against each other, with onsite spectators (S1,S2,S3) viewing the event from different viewpoints. Onsite spectator's (S1,S2,S3) positions are determined through GPS or a combination of different positioning technology. Onsite spectator's (S1,S2,S3) viewing angle is determined by sensors, like Gyroscope, within AR capable mobile device. Participant's (P1's and P2's) positions are determined through sensors, like proximity sensor, through onsite spectators AR capable device.

FIG. 3 illustrates the network flow to create live broadcast 3.11, playback and the database that helps build the content. It starts with onsite spectators (S1,S2,S3) having some sort of internet connection 3.2, that connects them to an AR application 106. The AR application 106 is connected to a server 3.1 that could be hardware, or cloud provider. This AR application 106 has several databases in said server 3.1, including Coded Marker database 3.4, AR Animation database 3.14, 2D Graphics database 3.5, Printable Coded Marker database 3.6 and Recorded Event database 3.7. The Coded Marker database 3.4 consist of coded images that have embedded “markers” using techniques mentioned previously. AR Animation database 3.14 consist of 3D AR content 3.13 that are connected to the Coded Marker database 3.4. These markers allow your AR enabled device(s) 10 to recognize the AR code, which will then overlay the marker on your mobile device 10. 2D Graphics database 3.5 consist of .gif, or related, animations 3.15 that an onsite spectator (S1,S2,S3) could take advantage of during live broadcasts 3.11. These animations 3.15, as mentioned above, include more than just .gif animations. Printable Coded Marker database 3.6 consist of printable versions from your Coded Marker database 3.4. Printable versions include, but not limited to, uncompressed, compressed and vector formats. Award printable marker 3.8 requires the participant (P1's and P2's) or spectator to complete a task 3.23 to get access to the award (example, participant (P1's and P2's) plays 5 days in a row, said participant (P1's and P2's) receives access to “Road Warrior” printable marker.) Sponsored printable marker 3.9 requires the participant (P1's and P2's) or spectator to complete a sponsored task 3.22 (example, if you join the Atlanta Hawks court unveil on April 12^{th} you will receive access to “Atlanta Hawks” printable marker.) Recorded Event Database 3.7 gathers information from live broadcasts 3.11 (feedback 3.12, AR content 3.13, 2D content 3.15, time stamps 3.12 . . . ) and allows users to view the recorded event 3.7 through their timeline feed 3.10, or invite. These markers are broken into 3 subsets: Free Printable Marker 3.16—all users have access to these markers, Award Printable Marker 3.8—when a participant (P1's and P2's) or onsite spectator (S1,S2,S3) complete award tasks 3.23, they will have access to said award marker, and Sponsored Markers 3.9—When a participant (P1's and P2's) or onsite spectator (S1,S2,S3) achieves a sponsored award 3.22, they will have access to said marker. 2D Effect 3.15 and AR Content 3.13 are the available tools for the onsite spectator (S1,S2,S3) to utilize during their live broadcast 3.11. The said tools are then configured 3.25, broadcasted to offsite spectators 3.20; while also saving the footage to Recorded database 3.7. Offsite spectators 3.20 have options to add feedback 3.12 when viewing an event live, or playback. Regardless of viewing type, live or playback, feedback 3.12 is timestamped to highlight the most action-packed times during said event. GPS 3.21, in this example, helps find the position of onsite spectator (S1,S2,S3).

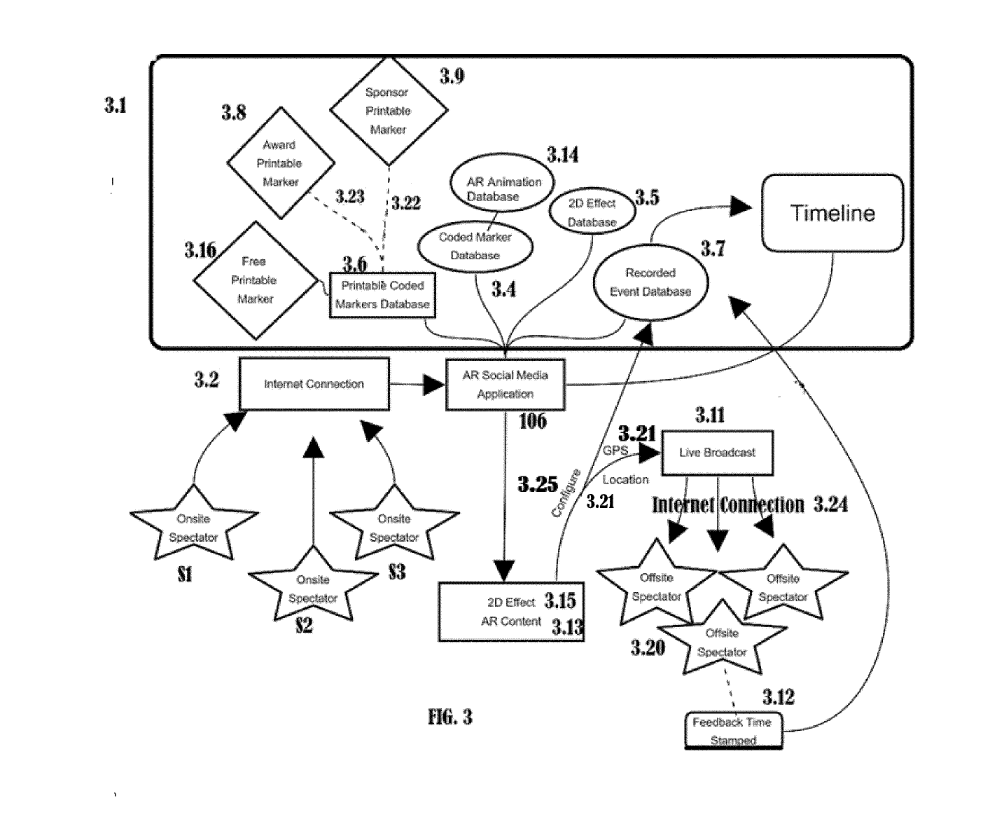

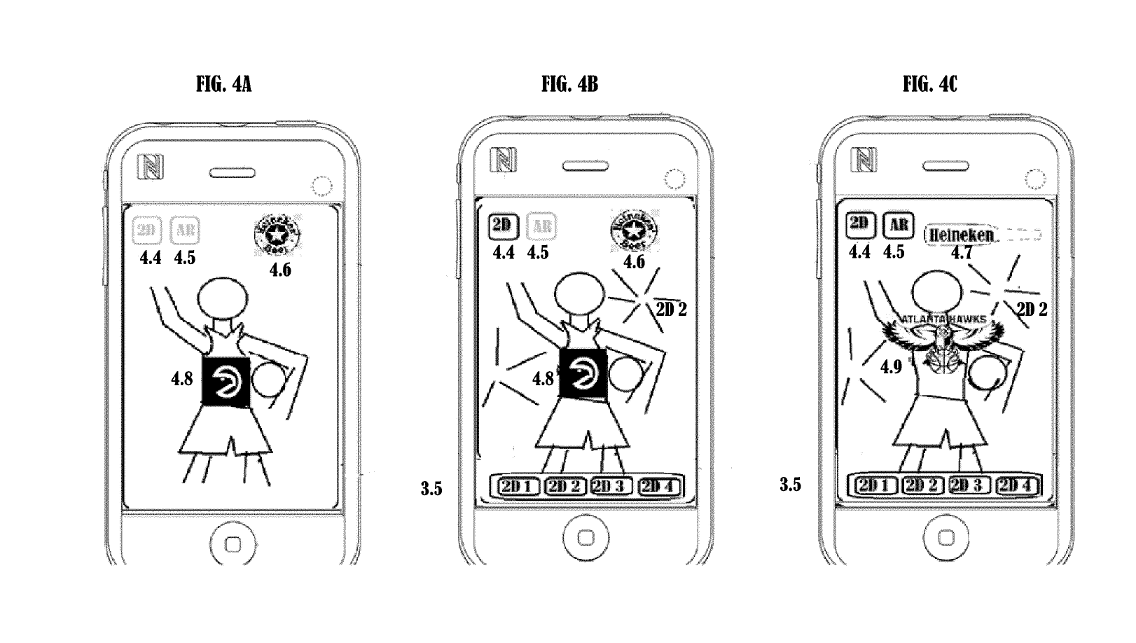

FIG. 4 illustrates the view(s) of an onsite spectator (S1,S2,S3). In the first view FIG. 4A, “2D” 4.4 and “AR” 4.5 option is not activated. This view shows footage as is, without any 2D 3.15 or 3D AR content 3.13. In the second view FIG. 4B, “2D” 4.4 is activated while “AR” 4.5 is inactive. An option, with a combination of 2D events 3.5 is now available as an option. The “firework” (2D2) 2D effect 3.15 is chosen in this illustration. While in this illustration the option bar shows on the bottom of the interface, several orientations are available to customize. In the third view FIG. 4C, both “2D” 4.4 and “AR” 4.5 are activated. Markers are now recognized and are overlaid by 3D AR content 3.13. This allows a user to customize the footage with a combination of effects. The “Heineken” logo 4.6 is now superimposed by an AR Heineken bottle 4.7, and the “Atlanta Hawks” logo 4.8 is superimposed by an animated AR logo/message 4.9. This illustrates how the 3D AR content 3.13 and 2D content 3.15 work in the different modes of the onsite spectator view (S1, S2, S3).

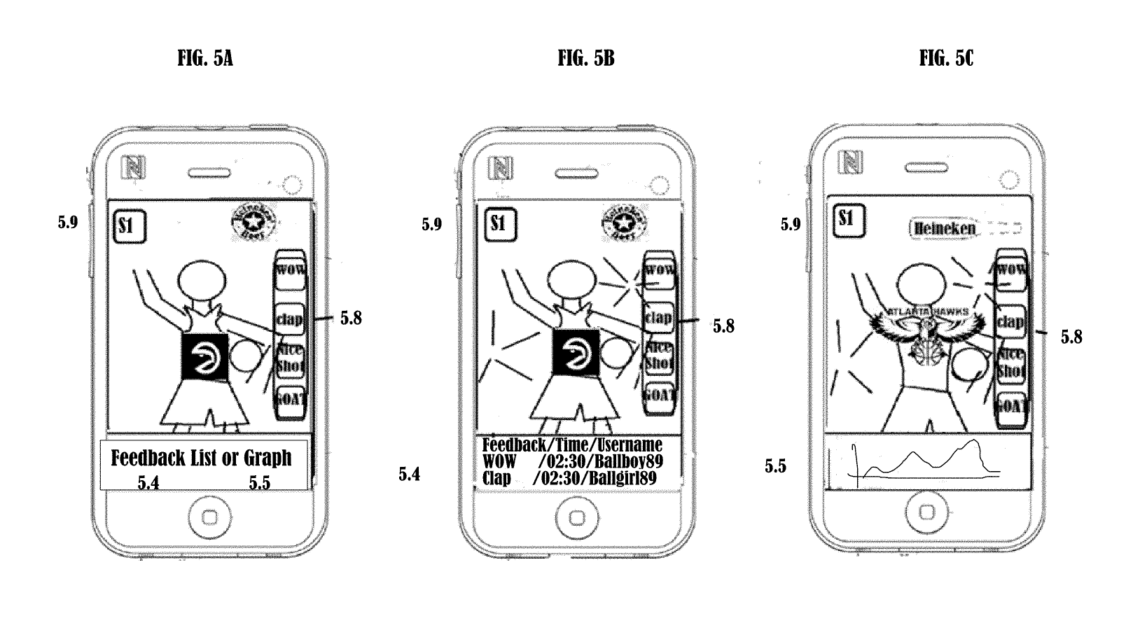

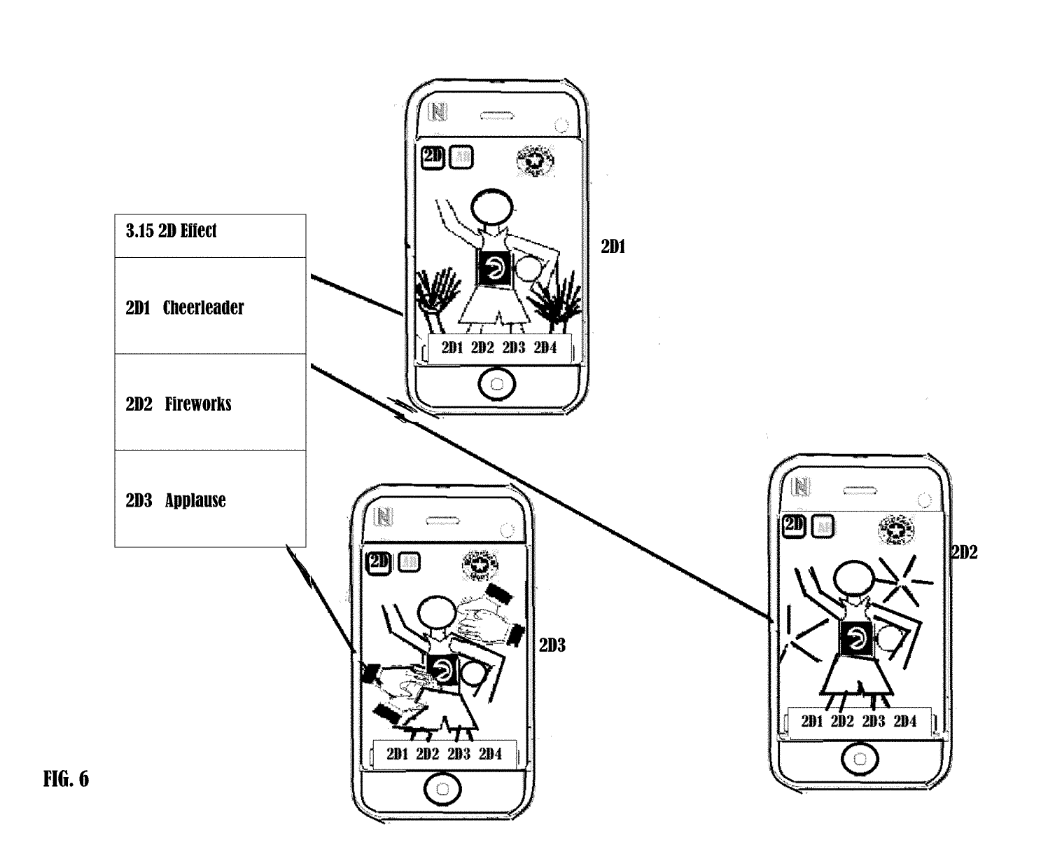

FIG. 5 illustrates the view(s) of an offsite spectator 3.20. The first view 5A represents the view with no “2D” 4.4 or “AR” option 4.5 active. This view FIG. 5A is representing the first view FIG. 4A from an offsite spectator 3.20. No special effects, with options of choosing a “list” 5.4 or “graph” 5.5 view for feedback 3.12. The second view FIG. 5B represents the view with “2D” 4.4 active, and “AR” 4.5 inactive, representing the second view FIG. 4B. In this view, feedback list 5.4 is the viewing option for feedback 3.12; time, feedback 3.12 and user's profile can be viewed in this option. The third view FIG. 5C represents the view with “2D” 4.4 and “AR” 4.5 option active, representing the third view FIG. 4C. In this view the graph 5.5 view is selected; x-a xis is time in minutes and seconds (example MM:SS, 12(min):12(sec)) and the y-axis is the number of people who left feedback (example, 1,2,3,4). On both graph 5.5 and list view 5.4, you can select a time and the video will fast-forward, or rewind, to the time you selected. In the list view 5.4, you could select any feedback time within the list. In the graph 5.5 view, you could slide the dot to which ever position on the graph that you desire. On each of the three views there is a feedback menu 5.8 that offsite spectators 3.20 have an option to select, to leave feedback 3.12 that is timestamped. The toggle button 5.9 represent the different onsite spectator views that the offsite spectator 3.20 could toggle through, these views FIG. 5A-5C represent the view of offsite spectator S1.

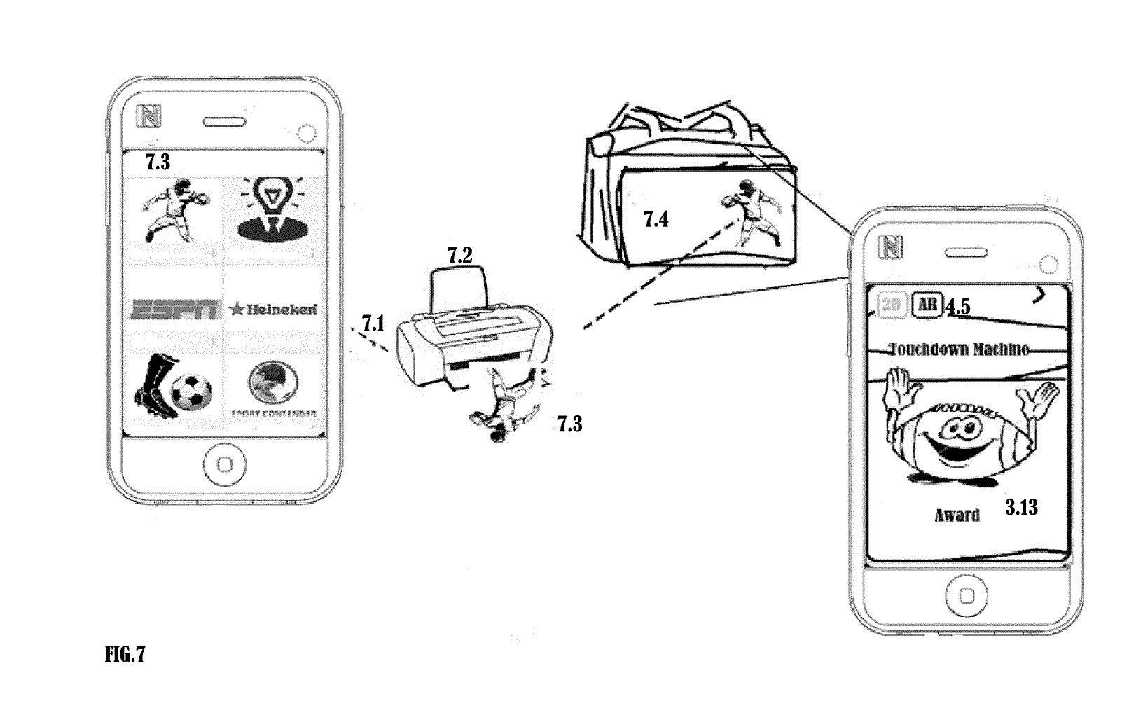

FIG. 6 illustrates how the 2D effect 3.15 button operates within the onsite spectator (S1,S2,S3) view. In this example, you have 3 options to choose from: Cheerleader 2D1, Fireworks 2D2 or Applause 2D3. During a live broadcast 3.11, onsite spectators (S1,S2,S3) could choose different 2D actions 3.15 to enhance their experience. Option 2D1 is a “Cheerleader” effect, where pom-poms overlay the live broadcast 3.11 with an animation and a cheer sound FIG. 6A is made. Option 2D2 is a “Fireworks” effect, where fireworks display around the UI and firework sound FIG. 6B is made. Option 2D3 is an “Applause” effect, where hands clapping animation overlays FIG. 6C the live broadcast 3.11 and makes a clapping sound. The 2D content 3.15 are recorded to recorded database 3.7.

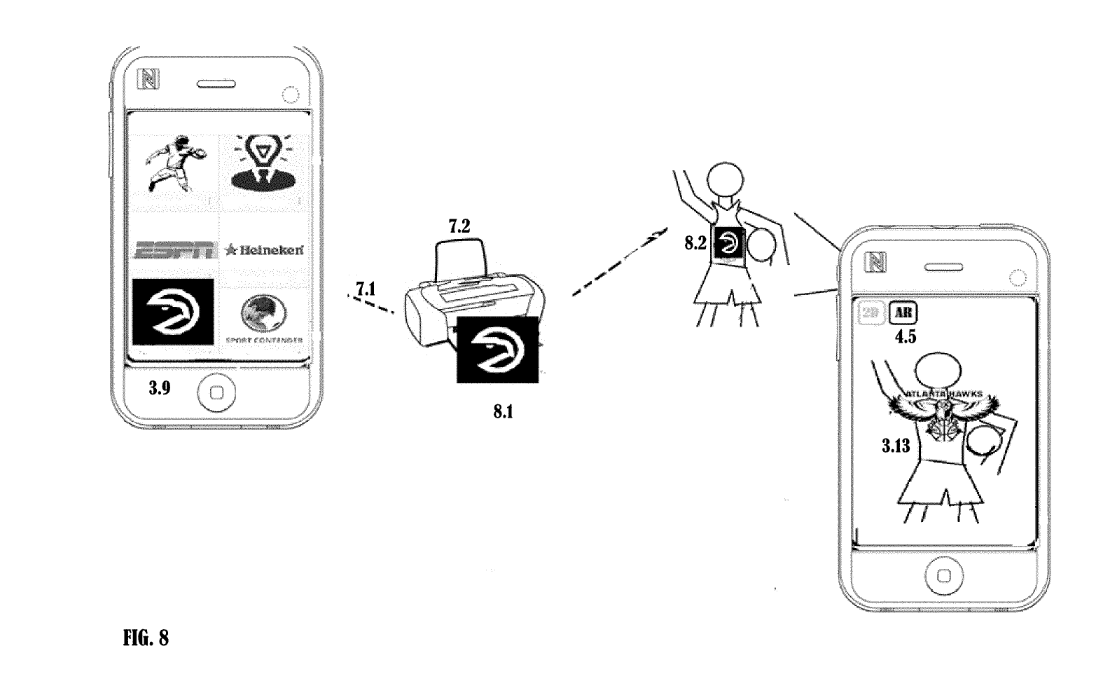

FIG. 7 illustrates a flow on how to print a coded marker 3.6. Once coded marker is selected from your mobile device 10, you could select a printing method 7.1. In this example, we use a regular printer 7.2 to print the marker. The marker is then printed 7.3, and stuck unto a bag 7.4 using pins, tape, sticker or similar sticking method. Using an AR enabled device 10, the camera recognizes the codes and produces 3D AR content 3.13.

In preferred embodiments, a user could have the art work 3.6 professionally printed onto stickers, or heat-pressed unto a shirt. What makes this unique from patent (textile augmentation) is an individual could have 1 shirt and heat-press, or stick, multiple markers on, whenever they want, not having to go to a huge manufacturer. Allowing participants (P1's and P2's) and onsite spectators (S1, S2, S3) to showcase multiple awards all at once.

FIG. 8 illustrates a flow on how to print a sponsored coded marker 3.9. Once sponsored marker 3.9 is selected from your mobile device 10, you could select a printing method 7.1. In this example, we use a regular printer 7.2 to print the marker 3.9. The marker 3.9 is then printed 8.1, and stuck unto a shirt 8.2 or participant (P1) using tape or similar sticking method. Using an AR enabled device 10, the camera recognizes the codes and produces AR content 3.13.

In preferred embodiments, a user could have the art work 3.9 professionally printed onto stickers, or heat-pressed unto a shirt. What makes this unique from patent (textile augmentation) is an individual could have 1 shirt and heat-press, or stick, multiple markers on, whenever they want, not having to go to a huge manufacturer. Allowing participants (P1's and P2's) and onsite spectators (S1,S2,S3) to showcase multiple awards all at once.

### II. Mobile Device

In more detail, FIG. 1 is a front elevational view of a smart phone or mobile device 10, which is the preferred form factor for the device discussed herein to illustrate certain aspects of the present invention. Mobile device 10 can be, for example, a handheld computer, a tablet computer, a personal digital assistant, a cellular telephone, a camera having a GPS and a radio, a GPS with a radio, a network appliance, a camera, a smart phone, an enhanced general packet radio service (EGPRS) mobile phone, a network base station, a media player, a navigation device, an email device, a game console, or other electronic device or a combination of any two or more of these data processing devices or other data processing.

Mobile device 10 includes a touch-sensitive graphics display 102. The touch-sensitive display 102 can implement liquid crystal display (LCD) technology, light emitting polymer display (LPD) technology, or some other display technology. The touch-sensitive display 102 can be sensitive to haptic and/or tactile contact with a user.

The touch-sensitive graphics display 102 can comprise a multi-touch-sensitive display. A multi-touch-sensitive display 102 can, for example, process multiple simultaneous touch points, including processing data related to the pressure, degree and/or position of each touch point. Such processing facilitates gestures and interactions with multiple fingers, chording, and other interactions. Other touch-sensitive display technologies can also be used, e.g., a display in which contact is made using a stylus or other pointing device. An example of a multi-touch-sensitive display technology is described in U.S. Pat. Nos. 6,323,846; 6,570,557; 6,677,932; and U.S. Publication No. 2002/0015024, each of which is incorporated by reference herein in its entirety. Touch screen 102 and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch screen 102.

Mobile device 10 can display one or more graphical user interfaces on the touch-sensitive display 102 for providing the user access to various system objects and for conveying information to the user. The graphical user interface can include one or more display objects 104, 106. Each of the display objects 104, 106 can be a graphic representation of a system object. Some examples of system objects include device functions, applications, windows, files, alerts, events, or other identifiable system objects.

Mobile device 10 can implement multiple device functionalities, such as a telephony device, as indicated by a phone object; an e-mail device, as indicated by the e-mail object; a network data communication device, as indicated by the Web object; a Wi-Fi base station device (not shown); and a media processing device, as indicated by the media player object. For convenience, the device objects, e.g., the phone object, the e-mail object, the Web object, and the media player object, can be displayed in menu bar 118.

Each of the device functionalities can be accessed from a top-level graphical user interface, such as the graphical user interface illustrated in FIG. 1. Touching one of the objects e.g. 104, 106, etc. can, for example, invoke the corresponding functionality. In the illustrated embodiment, object 106 represents an Artificial Reality application in accordance with the present invention.

Upon invocation of particular device functionality, the graphical user interface of mobile device 10 changes, or is augmented or replaced with another user interface or user interface elements, to facilitate user access to particular functions associated with the corresponding device functionality. For example, in response to a user touching the phone object, the graphical user interface of the touch-sensitive display 102 may present display objects related to various phone functions; likewise, touching of the email object may cause the graphical user interface to present display objects related to various e-mail functions; touching the Web object may cause the graphical user interface to present display objects related to various Web-surfing functions; and touching the media player object may cause the graphical user interface to present display objects related to various media processing functions.

The top-level graphical user interface environment or state of FIG. 1 can be restored by pressing button 120 located near the bottom of mobile device 10. Each corresponding device functionality may have corresponding “home” display objects displayed on the touch-sensitive display 102, and the graphical user interface environment of FIG. 1 can be restored by pressing the “home” display object.

The top-level graphical user interface is shown in FIG. 1 and can include additional display objects, such as a short messaging service (SMS) object, a calendar object, a photos object, a camera object, a calculator object, a stocks object, a weather object, a maps object, a notes object, a clock object, an address book object, and a settings object, as well as AR object 106. Touching the SMS display object can, for example, invoke an SMS messaging environment and supporting functionality. Likewise, each selection of a display object can invoke a corresponding object environment and functionality

Mobile device 10 can include one or more input/output (I/O) devices and/or sensor devices. For example, speaker 122 and microphone 124 can be included to facilitate voice-enabled functionalities, such as phone and voice mail functions. In some implementations, loud speaker 122 can be included to facilitate hands-free voice functionalities, such as speaker phone functions. An audio jack can also be included for use of headphones and/or a microphone.

A proximity sensor (not shown) can be included to facilitate the detection of the user positioning mobile device 10 proximate to the user's ear and, in response, disengage the touch-sensitive display 102 to prevent accidental function invocations. In some implementations, the touch-sensitive display 102 can be turned off to conserve additional power when mobile device 10 is proximate to the user's ear.

Other sensors can also be used. For example, an ambient light sensor (not shown) can be utilized to facilitate adjusting the brightness of the touch-sensitive display 102. An accelerometer (not shown) can be utilized to detect movement of mobile device 10, as indicated by the directional arrow. Accordingly, display objects and/or media can be presented according to a detected orientation, e.g., portrait or landscape.

Mobile device 10 may include circuitry and sensors for supporting a location determining capability, such as that provided by the global positioning system (GPS) or other positioning system (e.g., Cell ID, systems using Wi-Fi access points, television signals, cellular grids, Uniform Resource Locators (URLs)). A positioning system (e.g., a GPS receiver) can be integrated into the mobile device 10 or provided as a separate device that can be coupled to the mobile device 10 through an interface (e.g., port device 132) to provide access to location-based services.

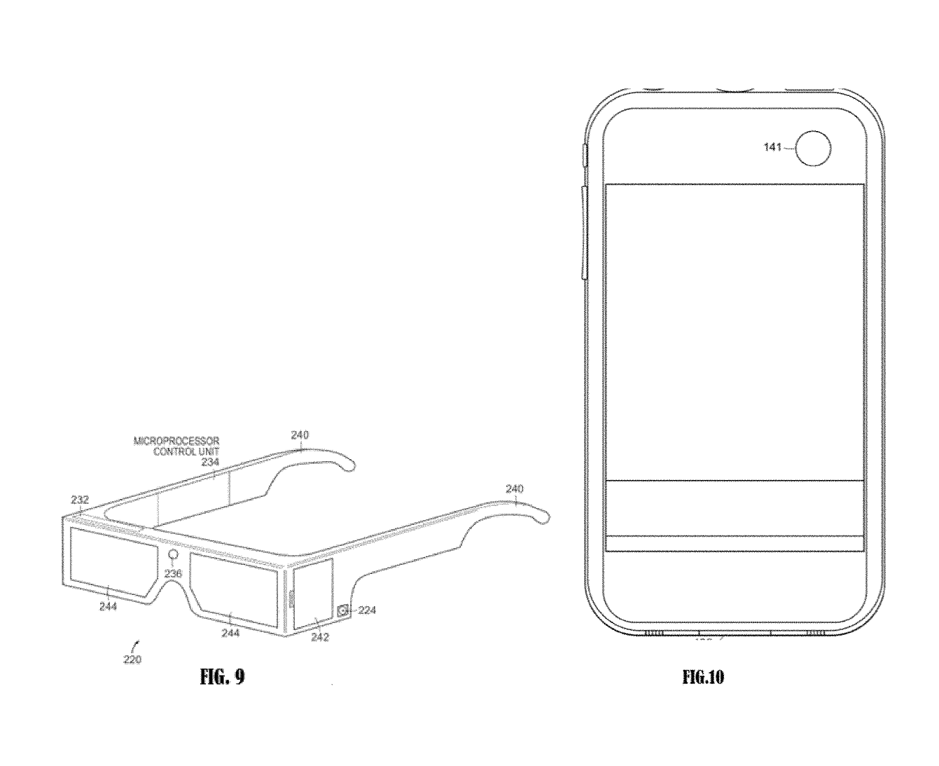

Mobile device 10 can also include a front camera lens and sensor 140. In a preferred implementation, a backside camera lens and sensor 141 is located on the back surface of the mobile device 10 as shown in FIG. 9. The cameras 140, 141 can capture still images and/or video. The camera subsystems and optical sensors 140, 141 may comprise, e.g., a charged coupled device (CCD) or a complementary metal-oxide semiconductor (CMOS) optical sensor, can be utilized to facilitate camera functions, such as recording photographs and video clips. Camera controls (zoom, pan, capture and store) can be incorporated into buttons 134-136 (FIG. 1.)

The preferred mobile device 10 includes a GPS positioning system. In this configuration, another positioning system can be provided by a separate device coupled to the mobile device 10, or can be provided internal to the mobile device. Such a positioning system can employ positioning technology including a GPS, a cellular grid, URLs, IMEO, pseudolites, repeaters, Wi-Fi or any other technology for determining the geographic location of a device. The positioning system can employ a service provided by a positioning service such as, for example, a Wi-Fi RSS system from SkyHook Wireless of Boston, Mass., or Rosum Corporation of Mountain View, Calif. In other implementations, the positioning system can be provided by an accelerometer and a compass using dead reckoning techniques starting from a known (e.g. determined by GPS) location. In such implementations, the user can occasionally reset the positioning system by marking the mobile device's presence at a known location (e.g., a landmark or intersection). In still other implementations, the user can enter a set of position coordinates (e.g., latitude, longitude) for the mobile device. For example, the position coordinates can be typed into the phone (e.g., using a virtual keyboard) or selected by touching a point on a map. Position coordinates can also be acquired from another device (e.g., a car navigation system) by syncing or linking with the other device. In other implementations, the positioning system can be provided by using wireless signal strength and one or more locations of known wireless signal sources (Wi-Fi, TV, FM) to provide the current location. Wireless signal sources can include access points and/or cellular towers. Other techniques to determine a current location of the mobile device 10 can be used and other configurations of the positioning system are possible.

Mobile device 10 can also include one or more wireless communication subsystems, such as a 802.11b/g/n communication device, and/or a Bluetooth™ communication device, in addition to near field communications. Other communication protocols can also be supported, including other 802.x communication protocols (e.g., WiMax, Wi-Fi), code division multiple access (CDMA), global system for mobile communications (GSM), Enhanced Data GSM Environment (EDGE), 3G (e.g., EV-DO, UMTS, HSDPA), etc. Additional sensors are incorporated into the device 10, such as accelerometer, digital compass and gyroscope. Further, peripheral sensors, devices and subsystems can be coupled to peripherals interface 132 to facilitate multiple functionalities. For example, a motion sensor, a light sensor, and a proximity sensor can be coupled to peripherals interface 132 to facilitate the orientation, lighting and proximity functions described with respect to FIG. 1. Other sensors can also be connected to peripherals interface 132, such as a GPS receiver, a temperature sensor, a biometric sensor, or other sensing device, to facilitate related functionalities.

Port device 132, is e.g., a Universal Serial Bus (USB) port, or a docking port, or some other wired port connection. Port device 132 can, for example, be utilized to establish a wired connection to other computing devices, such as other communication devices 10, a personal computer, a printer, or other processing devices capable of receiving and/or transmitting data. In some implementations, port device 132 allows mobile device 10 to synchronize with a host device using one or more protocols.

Input/output and operational buttons are shown at 134-136 to control the operation of device 10 in addition to, or in lieu of the touch sensitive screen 102. Mobile device 10 can include a memory interface to one or more data processors, image processors and/or central processing units, and a peripherals interface. The memory interface, the one or more processors and/or the peripherals interface can be separate components or can be integrated in one or more integrated circuits. The various components in mobile device 10 can be coupled by one or more communication buses or signal lines.

Preferably, the mobile device includes a graphics processing unit (GPU) coupled to the CPU. While a Nvidia GeForce GPU is preferred, in part because of the availability of CUDA, any GPU compatible with OpenGL is acceptable. Tools available from Kronos allow for rapid development of 3D models.

The I/O subsystem can include a touch screen controller and/or other input controller(s). The touch-screen controller can be coupled to touch screen 102. The other input controller(s) can be coupled to other input/control devices 132-136, such as one or more buttons, rocker switches, thumb-wheel, infrared port, USB port, and/or a pointer device such as a stylus. The one or more buttons (132-136) can include an up/down button for volume control of speaker 122 and/or microphone 124, or to control operation of cameras 140, 141. Further, the buttons (132-136) can be used to “capture” and share an image of the event along with the location of the image capture.

In one implementation, a pressing of button 136 for a first duration may disengage a lock of touch screen 102; and a pressing of the button for a second duration that is longer than the first duration may turn the power on or off to mobile device 10. The user may be able to customize a functionality of one or more of the buttons. Touch screen 102 can, for example, also be used to implement virtual or soft buttons and/or a keyboard.

In some implementations, mobile device 10 can present recorded audio and/or video files, such as MP3, AAC, and MPEG files. In some implementations, mobile device 10 can include the functionality of an MP3 player, such as an iPod™ Mobile device 10 may, therefore, include a 36-pin connector that is compatible with the iPod. Other input/output and control devices can also be used.

The memory interface can be coupled to a memory. The memory can include high-speed random access memory and/or non-volatile memory, such as one or more magnetic disk storage devices, one or more optical storage devices, and/or flash memory (e.g., NAND, NOR). The memory can store an operating system, such as Darwin, RTXC, LINUX, UNIX, OS X, WINDOWS, or an embedded operating system such as VxWorks. The operating system may include instructions for handling basic system services and for performing hardware dependent tasks. In some implementations, the operating system handles timekeeping tasks, including maintaining the date and time (e.g., a clock) on the mobile device 10. In some implementations, the operating system can be a kernel (e.g., UNIX kernel).

The memory may also store communication instructions to facilitate communicating with one or more additional devices, one or more computers and/or one or more servers. The memory may include graphical user interface instructions to facilitate graphic user interface processing; sensor processing instructions to facilitate sensor-related processing and functions; phone instructions to facilitate phone-related processes and functions; electronic messaging instructions to facilitate electronic-messaging related processes and functions; web browsing instructions to facilitate web browsing-related processes and functions; media processing instructions to facilitate media processing-related processes and functions; GPS/Navigation instructions to facilitate GPS and navigation-related processes and instructions; camera instructions to facilitate camera-related processes and functions; other software instructions to facilitate other related processes and functions; and/or diagnostic instructions to facilitate diagnostic processes and functions. The memory can also store data, including but not limited to coarse information, locations (points of interest), personal profile, documents, images, video files, audio files, and other data. The information can be stored and accessed using known methods, such as a structured or relative database.

Portable device 220 of FIG. 9 is an alternative embodiment in the configuration of glasses or goggles and includes a GPS and patch antenna 232, microprocessor 234, and radio 236. Controls, such as the directional pad 224, are on the side frames (opposite side not shown). Batteries are stored in compartment 242. The displays are transparent LCD's as at 244. Examples of such a device are the MyVue headset made by MicroOptical Corp. of Westwood, Mass. (see, U.S. Pat. No. 6,879,443), Vuzix Wrap 920 AR, 1200 VR, and Tac-Eye LT available from Vuzix Corporation, Rochester, N.Y. A particular benefit of the use of wearable glasses such as the embodiment of FIG. 8 is the ability to incorporate augmented reality messages, e.g. point of interest overlays onto the “real” background. In the basketball example, a spectator wearing glasses 220 can see the AR messages and selectively highlight a particular message and additional information relative to that message (e.g. weather info, participant statistics, participants AR awards, etc.). See, e.g. U.S. Pat. Nos. 7,002,551; 6,919,867; 7,046,214; 6,945,869; 6,903,752; 6,317,127 (herein incorporated by reference).

### IV. Graphics

The graphics generated on screen 102 can be 2D graphics, such as geometric models (also called vector graphics) or digital images (also called raster graphics). In 2D graphics, these components can be modified and manipulated by two-dimensional geometric transformations such as translation, rotation, scaling. In object oriented graphics, the image is described indirectly by an object endowed with a self-rendering method—a procedure which assigns colors to the image pixels by an arbitrary algorithm. Complex models can be built by combining simpler objects, in the paradigms of object-oriented programming. Modern computer graphics card displays almost overwhelmingly use raster techniques, dividing the screen into a rectangular grid of pixels, due to the relatively low cost of raster-based video hardware as compared with vector graphic hardware. Most graphic hardware has internal support for blitting operations and sprite drawing.

Preferably, however, the graphics generated on screen 102 are 3D. OpenGL and Direct3D are two popular APIs for the generation of real-time imagery in 3D. Real-time means that image generation occurs in “real time” or “on the fly”). Many modern graphics cards provide some degree of hardware acceleration based on these APIs, frequently enabling the display of complex 3D graphics in real-time. However, it's not necessary to employ any one of these to actually create 3D imagery. The graphics pipeline technology is advancing dramatically, mainly driven by gaming applications enabling more realistic 3D synthetic renderings of FIGS. 1,2,4 and 5.

3D graphics have become so popular, particularly in computer games, that specialized APIs (application programmer interfaces) have been created to ease the processes in all stages of computer graphics generation. These APIs have also proved vital to computer graphics hardware manufacturers, as they provide a way for programmers to access the hardware in an abstract way, while still taking advantage of the special hardware of this-or-that graphics card.

These APIs for 3D computer graphics are particularly popular:

OpenGL and the OpenGL Shading Language

OpenGL ES 3D API for embedded devices

Direct3D (a subset of DirectX)

RenderMan

RenderWare

Glide API

TruDimension LC Glasses and 3D monitor API

OpenGL is widely used and many tools are available from firms such as Kronos. There are also higher-level 3D scene-graph APIs which provide additional functionality on top of the lower-level rendering API.

Such libraries under active development include:

QSDK

Quesa

Java 3D

JSR 184 (M3G)

NVidia Scene Graph

OpenSceneGraph

OpenSG

OGRE

Irrlicht

Hoops3D

Photo-realistic image quality is often the desired outcome, and to this end several different, and often specialized, rendering methods have been developed. These methods range from the distinctly non-realistic wireframe rendering through polygon-based rendering, to more advanced techniques such as: scanline rendering, ray tracing, or radiosity. The rendering process is computationally expensive, given the complex variety of physical processes being simulated. Computer processing power has increased rapidly over the years, allowing for a progressively higher degree of realistic rendering. Film studios that produce computer-generated animations typically make use of a render farm to generate images in a timely manner. However, falling hardware costs mean that it is entirely possible to create small amounts of 3D animation on a small processor, such as in the device 10. Driven by the game studios, hardware manufacturers such as ATI, Nvidia, Creative Labs, and Ageia have developed graphics accelerators which greatly increase the 3D rendering capability. It can be anticipated that in the future, one or more graphics rendering chips, such as the Ageia Physx chip, or the GeForce GPU's will enable full rendering at the device 10.

While full 3D photorealistic rendering is difficult with the device 10 described herein standing alone, advances in processing and rendering capability will enable greater use of 3D graphics in the future. In the basketball application, the basketball court view (e.g., Atlanta Hawks training facility) can be rendered in advance and stored, making realistic 3D graphics possible. However, a preferred form is to use a cloud-based gaming provider, such as OTOY, OnLive, or Gaikai at server 44 networked to devices 10.

See, U.S. patent publication No 2008/0259096 (incorporated by reference).

### III. Network Operating Environment

In FIG. 3, a depiction of real-time network useful in many embodiments is shown. It should be understood that in many uses a real-time network environment as illustrated in FIG. 3 is not necessary. That is, information concerning an event can alternatively be recorded and uploaded to a social network server after the event. In the real-time embodiment of FIG. 3 onsite spectators (S1,S2,S3) communicate with cell base station 3.2 preferably using the cellular network which can include one or more femtocells or picocells. While simple data can be transmitted on the control plane (e.g. GPRS) preferably the cell radio uses a data plan, i.e. the user plane. The location, communication, and other data is communicated between onsite spectator (S1,S2,S3) and social media server 3.1 . Server 3.1 stores the position data of each spectator (S1,S2,S3) communicated to cell base station 3.2, and other pertinent data such as spectator viewing position, awards, etc. Such other data can, in addition to sensor data derived from device 10, comprise sensor data from the onsite spectator (S1,S2,S3), such as from 360 degree camera. See, e.g., U.S. Publication Nos. 2011/0143848 and 2008/0051208 (incorporated by reference). In a preferred form, server 3.1 stores the points of interest or course database which is used to create many of the AR messages.

Internet connection 3.24 is used to communicate among the offsite spectators 3.20 and onsite spectators (S1,S2,S3). The cell network is preferably used. 4G cellular networks such as LTE, or Long Term Evolution, have download speeds (e.g. 12 mbps) surpassing WiFi and may become acceptable substitutes. For example, WiMax (Sprint>10 mbps); LTE (Verizon 40-50 mbps) (AT&T unknown); and HSPA+ (T mobile 21 mbps) (AT&T 16 mbps) appear acceptable 4G network speeds. In many cases, with high performance 4G cellular networks, the social media server 3.1 need not be local, i.e. proximate to the basketball court. However, if a cell network is not used, the internet connection 3.24 of network of FIG. 3 can be local, i.e. a WiFi or 900 Mhz local area network is used. In this case radio 46 preferably uses WiFi (802.11b/g/n) to transmit to offsite spectators 3.20.

Some offsite spectators 3.20 may be remote from the sporting event. In this case, server 3.1 can transmit the desired information over internet connection 3.1 to the club house, home computer or television remote from the event. While one embodiment has been described in the context of a spectator in physical attendance at the golf course with information broadcast by radio, the use of device 10 at remote locations is equally feasible. In another embodiment more suited for remote locations, for example, portable device 10 can be used at home while watching a golf event on TV, with the participant location and other information streaming over the internet. WiFi in the home is a preferred mode of broadcasting the information between the portable device and the network.

One function of the server 3.1 is to allow observation of a round by an offsite spectator 3.20, either in real time 3.11 or post play 3.7. That is, the views of FIGS. 2-5 can be posted to the server 3.1 and observed by an offsite spectator 3.20 using any graphic device, including a personal computer, tablet, or a cell phone. Similar to using graphic device 10 coupled to the internet, a personal computer spectator can select the source or position of origination of the desired view, and the target or orientation from the source or target. Elevations, zoom, pan, tilt, etc. may be selected by the remote spectator as desired to change the origin viewpoint or size.

In “offsite spectator S1 view 5.1,” for example, the remote location graphic device might display only information from the onsite spectators S1 (FIG. 2). Alternatively, the offsite spectator might want a selectable view, such as behind the 3 point line (S4 FIG. 2), or other location such as from the west sideline (S2 FIG. 3) to the baskets location. In any of these modes, the remote location spectator could zoom, pan or tilt as described above, freeze, slow motion, replay, etc. to obtain a selected view on the portable device 10.

While the preferred embodiment contemplates most processing occurring at device 10, different amounts of preprocessing of the position data can be processed at server 3.1. For example, the participant information can be differentially corrected at the server (e.g. in addition to WAAS or a local area differential correction) or at device 10 or even information post-processed with carrier phase differential to achieve centimeter accuracy. Further, it is anticipated that most of the graphics rendering can be accomplished at portable device 10, but an engineering choice would be to preprocesses some of the location and rendering information at server 3.1 prior to broadcast. In particular, many smart phones and handheld computers include GPU's which enable photorealistic rendering and the developers have access to advanced tools for development such as OpenGL and CUDA.

Mobile device 10 of FIGS. 1 and 10 preferably accompanies some of onsite spectator (S1,S2,S3) of FIG. 3 in attendance of the basketball match. Devices 10 communicate over one or more wired and/or wireless networks 3.24 in data communication with server 3.1. In addition, the devices can communicate with a wireless network, e.g., a cellular network, or communicate with a wide area network (WAN), such as the Internet, by use of a gateway. Likewise, an access point associated with internet connection 3.24, such as an 802.11b/g/n wireless access point, can provide communication access to a wide area network.

Both voice and data communications can be established over the wireless network of FIG. 3 and access point 3.24 or using a cellular network. For example, mobile device 10 a can place and receive phone calls (e.g., using VoIP protocols), send and receive e-mail messages (e.g., using POP3 protocol), and retrieve electronic documents and/or streams, such as web pages, photographs, and videos, over the wireless network, gateway, and wide area network (e.g., using TCP/IP or UDP protocols). Likewise, mobile device 10 can place and receive phone calls, send and receive e-mail messages, and retrieve electronic documents over access point 3.26 and the wide area network. In some implementations, mobile device 10 can be physically connected to access point 3.26 using one or more cables and the access point can be a personal computer. In this configuration, mobile device 10 can be referred to as a “tethered” device.

Mobile devices 10 can also establish communications by other means. For example, wireless device 10 can communicate with other wireless devices, e.g., other wireless devices 10, cell phones, etc., over a wireless network. Likewise, mobile devices 10 can establish peer-to-peer communications, e.g., a personal area network, by use of one or more communication subsystems, such as the Bluetooth™ communication device. Other communication protocols and topologies can also be implemented.

In use in the play of basketball, it is believed preferable to use a real environment as the background, such as a digital image captured by backside camera 141 of FIG. 10. In many cases, this real background environment can be augmented with other award markers or sponsored markers. Typically, the offsite spectator 3.20 would toggle through the different onsite spectator (S1,S2,S3) views.

In other embodiments, a virtual environment may be used as the background. In such cases, server 3.1 preferably uses the OTOY, Gaikai, or OnLive video compression technology to transmit the participant position information the virtual background environment, as well as the AR objects, such as each car 54. OTOY (and Gaikai and OnLive) are cloud based gaming and application vendors that can transmit real time photorealistic gaming to remote gamers. Such companies that render photorealistic 3D games for realtime remote play are Otoy, see, e.g., www.otoy.com; OnLive, see, e.g., en.wikipedia.ordwiki/OnLive; and Gaikai, see, e.g., technabob.com/blog/2010/03/16/gaikai-cloud-based-gaming. Onlive, for example, advertises that with 5 mbps it can transfer 220 frames per second with 12-17 ms latency, employed advanced graphics—ajax, flash, Java, ActiveX.

The goal is high performance game systems that are hardware and software agnostic. That is, a goal is intense game processing performed on a remote server and communicated to the remote user. Using such cloud based gaming technology, smart phones 10 can run any of the advanced browsers (e.g. IE9 or Chrome) running HTML5 that support 3D graphics. However, other AR specific browsers can alternatively be used, such as available from Layar, Junaio, Wikitude, Sekai Camera or Mixare (www.mixare.org). While OTOY (and Gaikai and OnLive) promise no discernable latency in their gaming environment, server 3.1 for the basketball event of FIG. 3 is preferably placed at the venue of the event.

Therefore, the amount of processing occurring at server 3.1 versus device 10 is a design choice based on the event, the background, the radio network available, the computational and display capability available at device 10 or other factors.

In addition, the content of the advertisement messages can be changed based on context. Such smart phones 10 have not only machine ID's, but also search history, location history, and even personal information. Further, the user might be identified based on social media participation--e.g. Facebook or Twitter accounts. Such information is considered “context” in the present application, along with the typical demographics of an event and “marketing factors” as previously discussed. That is, the event might have its own context which indicates the demographic profile of most of the spectators at the event. A basketball match might have a context of basketball spectators with adequate disposable income to purchase a ticket to a professional basketball game. Therefore, advertising a Atlanta Hawk logo as shown in FIG. 8 makes advertising sense. See, U.S. patent publication No. 2012/0306907 (incorporated by reference).

In a preferred embodiment, an onsite spectator (S1,S2,S3) would “broadcast” his footage using the camera function and including his GPS coordinates and other sensor data (such as club selection) as described above. The onsite spectator (S1,S2,S3) would post his footage in real-time to the social media server 3.1. Using a social media relationship, an onsite spectator (S1,S2,S3) would “host” a match and provide access to offsite spectators 3.20, who might be selected followers or friends on the social media site. Preferably, the onsite spectator (S1,S2,S3) is the “host” of the event and the offsite spectators 3.20 are the gallery. The offsite spectators 3.20 can comment during play of the basketball such as providing praise and cheer.

While the play of basketball has been used to illustrate the use of the network 3 of FIG. 3, it should be understood that the event is not limited to a basketball. That is, many sporting events can be posted to a social media server 3.1 for broadcasting, feedback and awards. Soccer, Volleyball, as well as non-sport related activities can be shared via the social media server 3.1.

What is claimed:

1. A method of observing an event comprising:
electing to participate in the event having a physical location and time, where data associated with the event is stored on a social network;
creating a view of the event comprising an augmented reality (AR) content overlaid a background, 2D effects overlaid a background, wherein the background comprises an image created by an onsite spectator using an accompanying device and said AR content and/or 2D effect is applied to the background image;
storing said view of the event including said AR content and/or 2D effect on said social network, where access to said view and AR message is limited in distribution to members of said social network;
one or more members of said social network electing to participate as an onsite spectator for broadcast said view and AR message and 2d effect; selectively publishing said view and AR message/2D effect to said offsite spectator;
observing said view of the event by said offsite spectator in a perspective view with the AR message immediately discernable overlaid said background image and 2D effect overlay.

2. The method of claim 1, wherein said storing and said observing steps occur during said time of said event.

3. The method of claim 1, said creating step includes wherein said AR content is a physical marker that sticks directly onto promotion material.

4. The method of claim 3, wherein said promotional material are shirts, banners, bags, sportswear, hats, shoes or signs.

5. The method of claim 3, wherein the physical marker is put onto promotional material by sticker, heat press, tape or pin.

6. The method of claim 1, wherein the content of the AR message is related to the sponsored award or achievement award

7. The method of claim 1, wherein the content of the AR message is related to a participant ranking.

8. The method of claim 1, wherein the content of the AR message is related to type of event.

9. The method of claim 1, wherein the 2D content has both sound or .gif animations.

10. The method of claim 1, wherein 2D content and AR content can play simultaneously to create a better onsite and offsite spectator experience.

12. The method of claim 1, wherein onsite spectator is a spectator physically at the event and offsite spectator is a spectator viewing remotely.

13. The method of claim 1, wherein observing the event includes said spectator(s) wearing glasses to view said event with said AR messages and 2D effects discernible on said glasses.

14. A system for observing an event having a time and venue with members of a social network, comprising:
a server associated with said social network; an onsite spectator device accompanying an event onsite spectator during the time of the event to track positions of a participant in real time during the event at the event venue, creating a viewpoint and to create an augmented reality (AR) message overlaid/2D animated overlaid, a background proximate the onsite spectator position at the event venue wherein the background comprises an image created by the onsite spectator using the accompanying device and said AR message/2D animation is applied to the background image;
a communication link between said onsite spectator device in the event and said social network server to transmit onsite spectator positions and said onsite spectator AR message/2D animation to said server;
an offsite spectator device operably connected to said social network server for downloading information from said social network server, including said participant or onsite spectator (AR) message or 2D animation;
a communication link between said offsite spectator device and said social network server to communicate said (AR) message or 2D animation from said social network server; and
wherein said server and offsite spectator device being operable to permit said offsite spectator to observe said event in a perspective view including said onsite spectator AR message or 2D animation overlaid a background.

15. The system of claim 14, the onsite spectatort device including a GPS receiver for determining positions at the venue for the event.

16. The system of claim 14, at least one of said communication links comprising a cellular network.

17. The system of claim 14, wherein said server allows the offsite spectator device to communicate with said onsite spectator device in real time during the event time.

18. The system of claim 14, wherein said offsite spectator communication link and server permits the offsite spectator to award feedback to a participant that said onsite spectator is broadcasting.

19. The system of claim 14, wherein the background to said perspective view is a photo image or video background.

20. The system of claim 14, wherein said onsite spectator device is a mobile device accompanying one or more onsite spectator to broadcast said event.
